(19) United States
(12) Patent Application Publication
(10) Pub. No.: US 2023/0343026 A1
(43) Pub. Date: Oct. 26, 2023

(54) METHOD AND DEVICE FOR THREE-DIMENSIONAL RECONSTRUCTION OF BRAIN STRUCTURE, AND TERMINAL EQUIPMENT

(71) Applicant: SHENZHEN INSTITUTES OF ADVANCED TECHNOLOGY CHINESE ACADEMY OF SCIENCES, Shenzhen, Guangdong (CN)

(72) Inventors: Shuqiang WANG, Shenzhen, Guangdong (CN); Bowen HU, Shenzhen, Guangdong (CN); Yanyan SHEN, Shenzhen, Guangdong (CN)

(73) Assignee: SHENZHEN INSTITUTES OF ADVANCED TECHNOLOGY CHINESE ACADEMY OF SCIENCES, Shenzhen, Guangdong (CN)

(21) Appl. No.: 18/026,498

(22) PCT Filed: Jan. 8, 2021
(86) PCT No.: PCT/CN2021/070934

§ 371 Date: Mar. 15, 2023

(51) Int. Cl. G06T 9/00; G06T 19/20; G06T 17/00

(52) U.S. Cl. CPC G06T 17/00; G06T 9/002; G06T 19/20; G06T 2210/41; G06T 2219/2004

(57) ABSTRACT

A method and a device for a three-dimensional reconstruction of brain structure, and terminal equipment. The method includes steps of: obtaining a 2D image of a brain, inputting the 2D image of the brain into a 3D brain point-cloud reconstruction model that has been trained to be processed, and outputting a 3D point-cloud of the brain. The 3D brain point-cloud reconstruction model includes a ResNet encoder and a graphic convolutional neural network. The ResNet encoder is configured to extract a coding feature vector of the 2D image of the brain, and the graphic convolutional neural network is configured to construct the 3D point-cloud of the brain according to the coding feature vector.

### TECHNICAL FIELD

This disclosure relates to the field of artificial intelligence technology, and in particular to, a method and a device for a three-dimensional reconstruction of brain structure, and terminal equipment.

### BACKGROUND

In recent years, with the continuous development of medical surgery methods, minimally invasive surgery and robotic navigation surgery have gradually been applied to brain surgery. Doctors can observe the surgical site through micro probes, but the viewing angle of micro probes is limited, and images collected through the micro probes are two-dimensional (2D) images, which cannot provide more visual information for doctors, and thus is not conducive for doctors to accurately diagnose and analyze the lesions. Compared with the flat space of 2D images, the three-dimensional (3D) point-cloud data contains more spatial structure information, which can provide doctors with more visual information, thereby assisting the doctor for better diagnosis and treatment. Therefore, the reconstruction of 2D images into accurate and clear 3D point-clouds is of great significance.

### SUMMARY

Embodiment of the present application provides a method and a device for a three-dimensional reconstruction of brain structure, and terminal equipment, which can convert the 2D image of the brain into 3D point-clouds to provide doctors with more visual information.

In accordance with a first aspect of the embodiments of the present application, a method for a three-dimensional reconstruction of brain structure is provided, which includes steps of: obtaining a 2D image of a brain, inputting the 2D image of the brain into a trained 3D brain point-cloud reconstruction model to be processed, and outputting a 3D point-cloud of the brain. The 3D brain point-cloud reconstruction model includes: a residual network (ResNet) encoder and a graphic convolutional neural network. The ResNet encoder is configured to extract a coding feature vector of the 2D image of the brain. The graphic convolutional neural network is configured to construct the 3D point-cloud of the brain according to the coding feature vector.

Based on the method for the three-dimensional reconstruction of brain structure provided by the present application, the encoding feature information of image can be effectively extracted through the ResNet encoder, the encoding feature information can guide the graphic convolutional neural network to accurately construct the 3D point-cloud. This method enables the 2D image containing limited information to be reconstructed into the 3D point-cloud having richer and more accurate information, which thus can provide doctors with more and more accurate visual information about the lesion site in a process of diagnosis and treatment, thereby assisting the doctors to make better decisions.

Optionally, the graphic convolutional neural network includes multiple sets of graphic convolution modules and branch modules arranged alternatively, each graphic convolution module is configured to adjust position coordinates of point-clouds, and each branch module is configured to expand the number of point-clouds.

Based on the above optional method, the branch module can expand the number of point-clouds to a target number. The graphic convolution module can adjust the position coordinates of the point-cloud and reduce the dimension of the coordinates to be 3 dimensions, so that the target characteristics can be correctly described. By alternative uses of the graph convolution module and the branch module, the 3D point-cloud can be generated from top to bottom. In the case of retaining the location information of the ancestral point cloud, the relative position of the point cloud is fully utilized, thereby improving the accuracy of the reconstructed 3D point cloud.

Optionally, the 3D brain point-cloud reconstruction model is obtained by training based on a set of training samples and a corresponding discriminator. The set of training samples includes multiple training samples, each training sample comprises a 2D brain image sample and a 3D point-cloud sample of the brain corresponding to the 2D brain image sample.

Optionally, a training for the 3D brain point-cloud reconstruction model includes steps of: inputting, for each training sample, the 2D brain image sample in the training sample into an initial neural network model, to obtain a predicted 3D point-cloud; inputting the predicted 3D point-cloud and the 3D point-cloud sample in the training sample into the discriminator to be processed, so as to obtain a discrimination result of the training sample; and performing, according to the discrimination result of each training sample, an iterative training on a loss function of the 3D brain point-cloud reconstruction model and a loss function of the discriminator to obtain the 3D brain point-cloud reconstruction model.

Based on the above optional method, the graphic convolutional neural network and the discriminator in the neural network model constitute a generative adversarial network. There is no need for supervised learning in the training process, which reduces the training complexity of the model and improves the generalization ability of the model.

Optionally, the training sample is obtained by: obtaining a 3D image of the brain; performing an image pre-processing on the 3D image of the brain, and then slicing the 3D image of the brain to obtain the 2D brain image sample; and obtaining the 3D point-cloud sample of the brain according to the 3D image.

Based on the above optional method, the 3D point-cloud image obtained has been preprocessed to remove noises, which is convenient for subsequent image processing. The pre-processed 3D point-cloud image is sliced at different angles, and the clearest 2D image is selected as an input of ResNet encoder, which can improve the accuracy of 3D brain point-cloud reconstruction.

Optionally, the loss function corresponding to the 3D brain point-cloud reconstruction model is expressed as L_{E,G} = λ₁L_{KL} + λ₂L_{CD} + E_{z~Z} [D(G(z))]; where, L_{E,G} represents a loss value corresponding to the 3D brain point-cloud reconstruction model; λ₁ and λ₂ are constants; L_{KL} represents a KL divergence; Z represents a distribution of the coding feature vector generated by the ResNet encoder; z represents the coding feature vector; G(•) represents an output of the graph convolutional neural network, D(•) represents the discriminator and E(•) represents an expectation; L_{CD} is a chamfer distance between the 3D point-cloud predicted by the initial neural network model and the 3D point-cloud sample.

Optionally, the loss function corresponding to the discriminator is expressed as: L_{D} = E_{z~Z} [D(G(z))] - E_{Y~R} [D(Y)] + λ_{gp}E_{x̂} [(||∇_{x̂}D(x̂)||₂ -1)²]; where, x̂ represents a sampling of linear segmentation between the 3D point-cloud sample and 3D point-cloud predicted by the initial neural network model, x̂ = G(z) - Y ; E(•) represents an expectation, G(•) represents an output of the graph convolutional neural network, and D(•) represents the discriminator; Y represents 3D point-cloud sample; R represents a distribution of the 3D point-cloud sample; λ_{gp} is a constant; ∇ is a gradient operator.

Based on the above optional method, a loss function of a chamfer distance and a loss function of an earth mover distance are combined to construct the loss function of the 3D brain point-cloud reconstruction model. The classification accuracy of this model is higher than that of the existing model which is trained only by the loss function of the chamfer distance, which can improve the accuracy of the network, avoid the edge distortion of 3D point-cloud, and improve the generation quality of the point-cloud image.

In accordance with a second aspect of the embodiments of the present application, a device for a three-dimensional reconstruction of brain structure is provided, which includes an acquisition unit and a reconstruction unit. The acquisition unit is configured to obtain a 2D image of a brain. The reconstruction unit is configured to input the 2D image of the brain into a trained 3D brain point-cloud reconstruction model to be processed, and output a 3D point-cloud of the brain. The 3D brain point-cloud reconstruction model includes a ResNet encoder and a graphic convolutional neural network. The ResNet encoder is configured to extract a coding feature vector of the 2D image of the brain. The graphic convolutional neural network is configured to construct the 3D point-cloud of the brain according to the coding feature vector.

In accordance with a third aspect of the embodiments of the present application, terminal equipment is provided, including a memory, a processor, and a computer program that is stored in the memory and executable by the processor. The processor, when executing the computer program, enables any one of the methods in the first aspect to be implemented

In accordance with a fourth aspect of the embodiments of the present application, a computer-readable storage medium is provided, in which a computer program is stored, and the computer program when executed by a processor, enables any one of the methods in the first aspect to be implemented

In accordance with a fifth aspect of the embodiments of the present application, a computer program product is provided. The computer program product when run on the processor, causes the processor to perform any one of the methods as described in the first aspect.

It should be understood that, for beneficial effects in the second to fifth aspects, references may be made to the relevant descriptions in the above first aspect, which will not be repeated here.

### BRIEF DESCRIPTION OF THE DRAWINGS

In order to illustrate solutions in the embodiments of the present application or related technologies more clearly, the following will briefly introduce the drawings that need to be used in description of the embodiments or the related technologies. Obviously, the drawings in the following description are only some embodiments in the present application. For those of ordinary skills in this field, other drawings may also be obtained based on these drawings on the premise of paying no creative efforts.

FIG. 1 is a structural diagram of a 3D brain point-cloud reconstruction model in accordance with the present application;

FIG. 2 is a flow diagram of a method for a three-dimensional reconstruction of brain structure in accordance with the present application;

FIG. 3 is a structural diagram of a training 3D brain point-cloud reconstruction model in accordance with the present application;

FIG. 4 is a training flow diagram of the 3D brain point-cloud reconstruction model in accordance with the present application;

FIG. 5 is a structural diagram of a device for a three-dimensional reconstruction of brain structure in accordance with the present application; and

FIG. 6 is a structural diagram of terminal equipment in accordance with the present application.

### DETAILED DESCRIPTION OF THE EMBODIMENTS

In the following description, for the purpose of illustrations rather than limitations, specific details such as specific system structures and technologies are proposed to thoroughly understand the embodiments of the present application. However, it should be clear to those of ordinary skills in the art, that the present application may also be implemented in other embodiments without these specific details. In other cases, detailed descriptions of the well-known systems, devices, circuits, and methods are omitted, so as not to prejudice the description of the present application with unnecessary details.

It should be understood that the term “and/or” used in the specification and the attached claims of the present application refers to any combination of one or more of associated items listed and all possible combinations, and includes these combinations.

In addition, in the description of the specification and the attached claims, the terms “first”, “second”, and “third” are only used to distinguish descriptions, and cannot be understood as indicating or implying relative importance.

The description with reference to “an/one embodiment” or “some embodiments” in the specification of the present application means that specific features, structures, or characteristics described in conjunction with the embodiment are included in one or more embodiments of the present application. As a result, Thus, the statements “in one embodiment”, “in some embodiments”, “in some other embodiments”, “in some other embodiments”, etc. which appear in difference parts in this specification do not necessarily all refer to the same embodiments but mean “one or more but not all embodiments” unless otherwise specifically emphasized. The terms “including”, “containing”, “having” and their variations all mean “including but not limited to” unless otherwise specifically emphasized.

In recent years, with the continuous development of medical surgery methods, minimally invasive surgery and robotic navigation surgery have gradually been applied to brain surgery. Doctors can observe the surgical site through micro probes, but the viewing angle of micro probes is limited, and the images collected by micro probes are 2D images, which cannot provide more visual information for doctors, and thus is not conducive for doctors to accurately diagnose and analyze the lesions.

point-cloud is a data structure that describes a specific shape structure in a three-dimensional space, which has advantages of small spatial complexity, simple storage form, and high computing performance. Compared with the flat space of 2D images, the 3D point-cloud data contains more spatial structure information, which can provide doctors with more visual information, thereby assisting the doctors for better diagnosis and treatment. Therefore, the reconstruction of 2D images into accurate and clear 3D point-clouds is of great significance.

To this end, the present application provides a method for a device for a three-dimensional reconstruction of brain structure, and terminal equipment, which can convert the 2D image of the brain into a 3D point-clouds, providing better visual information for doctors, thereby assisting the doctors for better diagnosis and treatment.

In the following, a 3D brain point-cloud reconstruction model and a training method thereof, as well as the method for the three-dimensional reconstruction of brain structure, provided by the present application are introduced in detail with reference to the drawings.

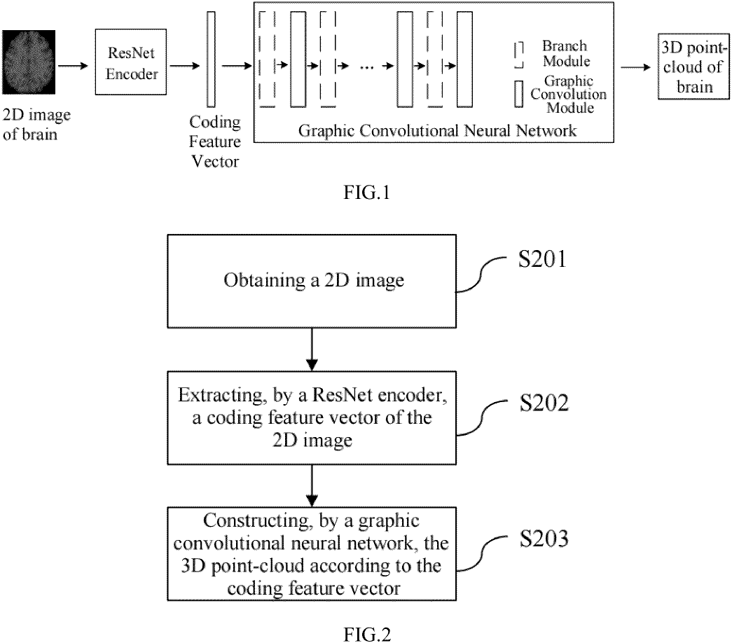

FIG. 1 is a 3D brain point-cloud reconstruction model in accordance with the present application. This model includes: a residual network (ResNet) encoder and a graphic convolutional neural network (GCN). The graphic convolutional neural network is a generator of the 3D brain point-cloud reconstruction model, including multiple sets of branch modules and graphic convolution modules arranged alternately.

In this embodiment, a 2D image of a brain is input into the ResNet encoder, the ResNet encoder can extract a coding feature vector of the 2D image. The ResNet encoder first quantifies the 2D image into a characteristic vector that has a certain mean and variance and obeys the Gaussian distribution, then randomly extracts a high-dimensional coding feature vector of a preset dimension (e.g., 96-dimentional coding feature vector) from the feature vector, and then pass the coding feature vector to the graphic convolutional neural network. The coding feature vector is an initial point-cloud being input into the graphic convolutional neural network, and has a coordinate dimension of 96.

In the graphic convolutional neural network, the branch module is configured to expand the number of point-clouds. The graphic convolution module is configured to adjust position coordinates of each point-cloud. The 3D point-cloud of the brain can accurately be reconstructed by alternatively using the branch module and the graphic convolution module.

In one embodiment, the 2D image of the brain may be magnetic resonance imaging (MRI), computed tomography (CT), positron emission computed tomography (PET), diffusion tensor imaging (DTI), or functional magnetic resonance imaging (FMRI), taken at any angle.

FIG. 2 is a flow diagram of a method for a three-dimensional reconstruction of brain structure in accordance with an embodiment of the present application. An execution subject in this method may be image data acquisition equipment, such as the positron emission computed tomography PET equipment, CT equipment, or other terminal equipment such as MRI equipment, etc. The execution subject may also be a control device, a computer, a robot, a mobile terminal and other terminal devices of the image data collection equipment. As shown in FIG. 2, the method includes steps S201-S203.

In step S201, a 2D image of a brain is obtained.

The size of the 2D image meets input requirements of the ResNet encoder. The 2D image may be a brain image such as MRI, CT, PET, DTI, or FMRI taken at any angle. It should be noted that, in order to obtain a more accurate 3D point-cloud, the 2D image taken at an angle where more brain characteristics are shown may be selected.

In step S202, the 2D image of the brain is input into a ResNet encoder to obtain a coding feature vector.

In this embodiment, the ResNet encoder first quantifies the 2D image of the brain into a characteristic vector that has a certain average µ and variance σ and obeys the Gaussian distribution, then randomly extracts the coding feature vector z of 96-dimensional from the feature vector, and then pass the coding feature vector z to the graphic convolutional neural network. This coding feature vector serves as the initial point-cloud that input into the graphic convolutional neural network, having a number of 1 and a coordinate dimension of 96.

In step S203, a 3D point-cloud of the brain is constructed by the graphic convolutional neural network according to the coding feature vector.

As shown in FIG. 1, the graphic convolutional neural network includes multiple sets of branch modules and graphic convolution modules arranged alternatively. The branch module is capable of mapping one point-cloud into multiple point-clouds, then, one initial point-cloud may be gradually expanded to a target number of point-clouds through multiple branch modules. The graphic convolution module is configured to adjust the position coordinates of each point-cloud. Multiple graph convolution modules are used to raise or reduce the dimension of coordinates of each point-cloud being input, so as to gradually reduce the dimension of coordinates of the point-cloud from 96 to 3. Therefore, through the multiple sets of graphic convolution modules and branch modules arranged alternatively, the graphic convolutional neural network is enabled to generate a 3D point-cloud having a specific number of point-clouds in the end, and each point-cloud has a 3-dimensional position coordinate.

The branch module obeys the formula (1):

$${p}_{i}^{l + 1} , {p}_{i + 1}^{l + 1} , … , {p}_{i + n}^{l + 1} = {p}_{i}^{l} \qquad \text{(1)}$$

In the formula (1),

$${p}_{i}^{l}$$

represents the i-th point-cloud in the l-th network layer of the graphic convolutional neural network;

$${p}_{i}^{l + 1}$$

represents the i-th point-cloud in the (l+1)-th network layer network of the graphic convolutional neural network;

$${p}_{i + 1}^{l + 1}$$

represents the (i+1)-th point-cloud in the (l+1)-th network layer network of the graphic convolutional neural network;

$${p}_{i + \text{n}}^{l + 1}$$

represents the the (i+n)-th point-cloud in the (l+1)-th network layer network of the graphic convolutional neural network.

In other words, in this embodiment, the branch module is capable of copying the coordinates of each point-cloud in the upper layer n times separately. If there are a (i ∈ a) point-clouds on the upper layer and the coordinates of each point-cloud is copied n times, then the branch module of this layer can expand the number of point-clouds into a × n, and then pass the a × n coordinates of point-cloud to the next layer. If the graphic convolutional neural network includes b (l ∈ b, and b ≥ 1, b is a positive integer) branch modules, and each branch module has the same expansion multiple, i.e., n, then each point-cloud is expanded by each branch module in the graphic convolutional neural network to have n coordinates, after one initial point-cloud is input by the ResNet encoder into the graphic convolutional neural network, and the 3D point-cloud that is finally generated by the graphic convolutional neural network contains n^{b} point-clouds.

It should be understood that the extension multiple of each branch module may also be different. For example, the extension multiple of the first layer branch module is 5, which can expand the initial point-cloud input to 5 point-clouds. The extension multiple of the second layer branch module is 10, and the second layer can expand 5 point-clouds to 50 point-clouds after receiving 5 point-clouds.

The graphic convolution module obeys the formula (2):

$${p}_{i}^{l + 1} = σ \left({F}^{l} {}_{K} \left({p}_{i}^{l}\right) + {\sum }_{{q}_{j} ∈ A \left({p}_{i}^{l}\right)} {U}^{l} {}_{j} {q}_{j} + {b}_{l}\right) \qquad \text{(2)}$$

In the formula (2),

$${F}^{l} {}_{K}$$

represents K perceptions in the l-th layer;

$${F}^{l} {}_{K} \left({p}_{i}^{l}\right)$$

is a full-connection layer, and represents a mapping relationship between nodes in the l-th layer and nodes in the (l+1)-th layer;

$$A \left({p}_{i}^{l}\right)$$

represents a collection of all nodes (that is, ancestor nodes) from the 1-st layer to the (l-1)-th layer that correspond to the i-th node in the l-th layer

$${p}_{i}^{l} ; {U}_{j}^{l}$$

is a sparse matrix;

$${\sum }_{{q}_{j} ∈ A \left({p}_{i}^{l}\right)} {U}^{l} {}_{j} {q}_{j}$$

represents a characteristic distribution of the ancestral nodes of the nodes in the l-th layer to the nodes in the (l+1)-th layer; bₗ is a bias parameter; σ(•) represents an activation function.

Based on the method for 3D point-cloud reconstruction provided by the present application, the encoding feature information of the image can be effectively extracted through the ResNet encoder. The encoding feature information can guide the graphic convolutional neural network to accurately construct the 3D point-cloud. This method enables the 2D image containing limited information to be reconstructed into the 3D point-cloud having richer and more accurate information, which thus can provide doctors with more and more accurate visual information about the lesion site in a process of diagnosis and treatment, thereby assisting the doctors to make better decisions.

It should be understood that, in addition to reconstructing the 3D point-cloud of the brain, the model for 3D point-cloud of the brain provided by the present application may also be used to reconstruct a 3D point-cloud of various organs in the medical field, and may also be applied to the field of construction and manufacturing, such as 3D point-clouds for reconstruction of houses, crafts, etc.

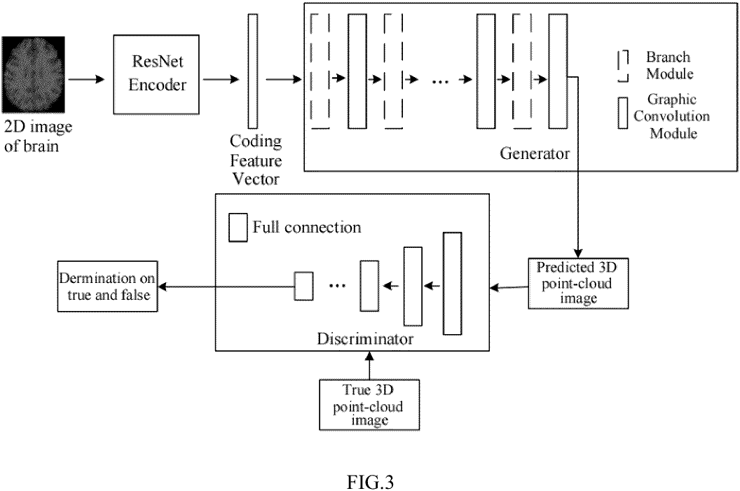

FIG. 3 is a training 3D brain point-cloud reconstruction model in accordance with the present application. This model includes: the ResNet encoder, the graphic convolutional neural network, and a discriminator. The graphic convolutional neural network and the discriminator constitute a generative adversarial network. The 3D point-cloud predicted by the graphic convolutional neural network and the 3D point-cloud sample are input to the discriminator to obtain a discrimination result. An iterative training is carried out, according to the discrimination result, on a loss function of the 3D brain point-cloud reconstruction model and a loss function of the discriminator to obtain the 3D brain point-cloud reconstruction model. The trained 3D point-cloud reconstruction model may be used to construct a 3D point-cloud corresponding to the 2D image of the brain.

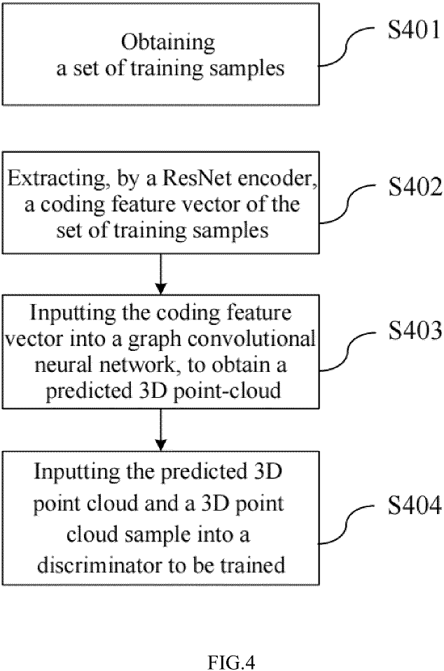

The training flow diagram of the 3D brain point-cloud reconstruction model is shown in FIG. 4. The training process is as follows.

In step S401, a set of training samples is obtained.

The set of training samples includes multiple training samples. Each training sample includes a 2D brain image sample and a 3D point-cloud sample of the brain corresponding to the 2D brain image sample. Firstly, a 3D image of the brain is obtained, and then the 3D image of the brain, after an image preprocessing, is sliced to obtain the corresponding 2D brain image sample. According to the 3D image of the brain, the corresponding 3D point-cloud sample of the brain can also be obtained. The 3D point-cloud sample of the brain is a real 3D point-cloud image of the brain.

Exemplarily, the 3D brain MRI image is taken as an example. Firstly, a real 3D brain MRI image is obtained. Then, the real 3D brain MRI image, after being preprocessed, is sliced at different angles to select a 2D sliced image near the best plane as the 2D brain image sample of the training sample. In addition, the 3D point-cloud sample is obtained based on the 1-st 3D brain MRI image.

In one embodiment, the real 3D brain MRI image is preprocessed by cleaning and denoising, skull removal and neck bone removal.

In one embodiment, the 2D sliced image near the best plane can artificially select the clearest and largest 2D sliced image, or select the 2D sliced image of the middle layer as the 2D brain image sample.

In steps S402, a coding feature vector of the set of training samples is extracted through a ResNet encoder.

In a possible implementation, a 2D image sample may be represented I_{HxW}, in which H and W represents the length and width of the image, respectively. After I_{H×W} input into the ResNet encoder, the ResNet can quantify the features of the input image I_{H×W} into a Gauss distributed vector having a specific average µ and variance σ, and randomly extract the 96-dimensional coding feature vector from the vector z ~ N(µ,σ²), and pass the coding feature vector z to the graphic convolutional neural network. the KL divergence can be calculated by the Resnet through the formula (3).

$${L}_{K L} \left(Q , P\right) = {\sum }_{x ∈ X} Q \left(x\right) log \left(\frac{Q \left(x\right)}{P \left(x\right)}\right) \qquad \text{(3)}$$

In the formula (3), L_{KL} is KL divergence; X is a total number of Q values or P values; Q(x) is the x-th probability distribution obtained by the encoder according to the coding feature vector; P(x) is the preset x-th probability distribution.

In step S403, the coding feature vector is input into the graphic convolutional neural network, to obtain a predicted 3D point-cloud.

This step is implemented in detail as described in S203 above, which will not be repeated here.

In step S404 the predicted 3D point-cloud and the 3D point-cloud sample are input into the discriminator for training.

In this embodiment, as shown in FIG. 3, the discriminator includes multiple full-connection layers. The input of the discriminator is the predicted 3D point-cloud and the 3D point-cloud sample, and the discriminator can determine the true or false probability of each predicted 3D point-cloud of the brain, if it is determined to be definitely true, the probability is 1. If it is determined to be definitely false, the probability is 0. And, a difference between the predicted 3D point-cloud G(z) and 3D point-cloud sample Y is calculated based on the actual true and false situation of point-cloud, and the difference can be expressed as a formula of G(z)-Y.

In the process of training, the ResNet encoder and the graphic convolutional neural network use the same loss function and are trained together, while the discriminator is trained separately. The loss function of ResNet encoder and the graphic convolutional neural network is expressed as the formula (4):

$${L}_{E , G} = {λ}_{1} {L}_{K L} + {λ}_{2} {L}_{C D} + {E}_{z \sim Z} \left[D \left(G \left(z\right)\right)\right] \qquad \text{(4)}$$

In the formula (4), L_{E,G} is the loss function of the ResNet encoder and the graphic convolutional neural network; λ₁ and λ₂ the constant; L_{KL} the KL divergence of the formula (1); Z is a distribution of coding feature vectors generated by the ResNet encoder; z represents the coding feature vector, which is equivalent to Q(x); G(z) is the 3D point-cloud predicted by the graphic convolutional neural network; D(G(z)) represents a value obtained after the 3D point-cloud predicted by the graphic convolutional neural network is input into the discriminator; E(•) represents an expectation; L_{CD} is a chamfer distance (CD) between the 3D point-cloud predicted by the graphic convolutional neural network and the 3D point-cloud sample, and the chamfer distance can be expressed as a formula (5):

$${L}_{C D} = {\sum }_{{y}^{′} ∈ {Y}^{′}} {min}_{y ∈ Y} {\left‖{y}^{′} - y\right‖}_{2}^{2} + {\sum }_{y ∈ Y} {min}_{{y}^{′} ∈ {Y}^{′}} {\left‖y - {y}^{′}\right‖}_{2}^{2} \qquad \text{(5)}$$

In the formula (5), Y is a coordinate matrix of all real 3D point-clouds, y is a point-cloud coordinate vector in the matrix Y ; Y′ a coordinate matrix of all predicted 3D point-cloud obtained by the graphic convolutional neural network, y′ is a point-cloud coordinate vector in the matrix Y′. For example, if Y is a m × 3 matrix composed of m point-cloud coordinates, then y is a coordinate vector having a size of 1 × 3 corresponding to one point-cloud in the matrix Y.

The loss function of the discriminator is derived from the loss function of the earth mover distance (EMD), and may be specifically expressed as a formula (6):

$${L}_{D} = {E}_{z \sim Z} \left[D \left(G \left(z\right)\right)\right] - {E}_{Y \sim R} \left[D \left(Y\right)\right] + {λ}_{g p} {E}_{\hat{x}} \left[{\left({\left‖{∇}_{\hat{x}} D \left(\hat{x}\right)\right‖}_{2} - 1\right)}^{2}\right] \qquad \text{(6)}$$

In the formula (6), x̂ represents a linear segmentation sampling between the 3D point-cloud sample and the predicted 3D point-cloud, that is, a difference between the 3D point-cloud sample and the predicted 3D point-cloud, x̂ = G(z) - Y ; E(•) is an expectation; D(G(z)) represents a value obtained after the 3D point-cloud predicted by the graph convolutional neural network is input into the discriminator; D(Y) represents a value obtained after the 3D point-cloud sample is input into the discriminator; R is a distribution of 3D point-cloud samples; λ_{gp} is a constant; ∇ is a gradient operator.

It is indicated that the model has converged when the loss function of the discriminator and the loss function of the 3D brain point-cloud reconstruction model both meet the requirements. The initial 3D brain point-cloud reconstruction model has been trained, to obtain a trained 3D brain point-cloud reconstruction model.

The trained 3D brain point-cloud reconstruction model can be used to construct the 3D point-cloud corresponding to the 2D image. The 3D brain point-cloud reconstruction model provided by an embodiment of the present application has combined the ResNet encoder and the graphic convolutional neural network. The discriminator is incorporated into the training model to enable the graph convolutional neural network and the discriminator to constitute a generative adversarial network. The ResNet encoder can effectively extract the coding feature vector of the input image, which provides priority guidance for the generative adversarial network, enabling the training process of the generative adversarial network to be easier. In addition, the present application expands the number of point-clouds and adjust the position coordinates of the point-clouds through alternate uses of the graphic convolution module and the branch module, so that the 3D point-cloud predicted by the graphic convolutional neural network is more accurate. In the process of training, the loss function of chamfer distance and the loss function of earth mover distance are combined to train the model, The classification accuracy of the model is higher than that of the existing model trained only by the loss function of chamfer distance.

Table 1 shows some comparative results of the 3D brain point-cloud reconstruction model provided by the present application and the PointoutNet model (a 3D point-cloud reconstruction model) on the chamfer distance, point-to point error and classification accuracy. It can be seen from Table 1 that the 3D brain point-cloud reconstruction model provided by the present application is better than the PointoutNet model in terms of the three indicators.

TABLE 1

| Indicator | Model | |
|---|---|---|
| | 3D brain point-cloud reconstruction model | PointOutNet |
| Chamfer distance | 0.15 | 0.23 |
| Point to point error | 3.24×10⁻⁵ | 4.11×10⁻⁵ |
| Classification accuracy | 88.60% | 85.70% |

FIG. 5 is a structural schematic diagram of a device for a three-dimensional reconstruction of brain structure provided by the present application. The device for the three-dimensional reconstruction of brain structure includes: an acquisition unit 501 and a reconstruction unit 504 and a storage unit 505. The acquisition unit 501 is configured to obtain a 2D image of a brain. The storage unit 505 is configured to store a trained 3D brain point-cloud reconstruction model. The reconstruction unit 504 is configured to input the 2D image of the brain into the trained 3D brain point-cloud reconstruction model to be processed, and output a 3D point-cloud of the brain; The trained 3D brain point-cloud reconstruction model includes a ResNet encoder and a graph convolutional neural network. The ResNet encoder is configured to extract a coding feature vector of the 2D image of the brain. The graphic convolutional neural network is configured to construct the 3D point-cloud of the brain according to the coding feature vector.

In one embodiment, the acquisition unit 501 is also configured to obtain a 3D image of the brain, and the storage unit 505 is configured to store a set of training samples.

In a possible implementation, the device for the three-dimensional reconstruction of brain structure also includes an image processing unit 502 and a training unit 503.

In this embodiment, the image processing unit 502 is configured to preprocess and slice the 3D image of the brain obtained by the acquisition unit 501 to obtain the set of training samples. The set of training samples includes multiple training samples. Each training sample includes a 2D brain image sample and a 3D point-cloud sample corresponding to the 2D brain image sample. Pre-processing includes cleaning and denoising, skull removal and neck bone removal. The 3D image of the brain, after being preprocessed, is sliced at different angles, and the 2D sliced image near the best plane is selected as the 2D image sample of the training sample.

The training unit 503 is configured to train the 3D brain point-cloud reconstruction model. For each training sample, the 2D brain image sample of the training sample is input into an initial neural network model to obtain a predicted 3D point-cloud of the brain. The predicted 3D point-cloud of the brain and the 3D point-cloud sample of the brain of the training sample into a discriminator to obtain a discrimination result. An iterative training is carried out according to the discrimination result, on a loss function of the 3D brain point-cloud reconstruction model and a loss function of the discriminator to obtain the 3D brain point-cloud reconstruction model.

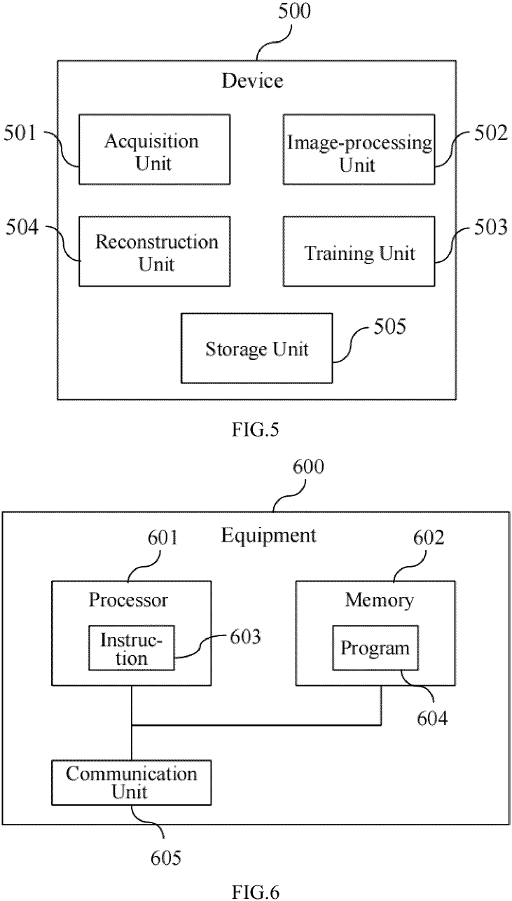

FIG. 6 is a structural diagram of equipment for the 3D point-cloud reconstruction of brain structure provided by the present application. Equipment 600 may be terminal equipment or a server or a chip. Equipment 600 includes one or more processors 601, and the one or more processor 601 is capable of supporting an implementation of the method described in the above method embodiments. The processor 601 may be a general processor or a dedicated processor. For example, the processor 601 may be a central processor unit (CPU). The CPU may be used to control the equipment 600, execute software programs, and process the data of the software program.

In one embodiment, the equipment 600 may include a communication unit 605, configured for an input (receiving) and output (sending) of signals. For example, the equipment 600 may be a chip, the communication unit 605 may be an input and/or output circuit of the chip, or, the communication unit 605 may be a communication interface of the chip, and the chip may be used as a component of the terminal equipment or network equipment or other electronic equipment. For another example, the equipment 600 may be terminal equipment or a server, and the communication unit 605 may be a transceiver of the terminal equipment or the server, or, the communication unit 605 may be a receiving circuit of the terminal equipment or the server.

In another embodiment, one or more memory 602 may be included in the equipment 600, and on the memory, a program 604 is stored. The program 604 may be executed by the processor 601 to generate an instruction 603, which enables the processor to perform the method described in the above method embodiments according to the instruction 603.

In other embodiments, data may also be stored in the memory 602 (such as the 3D point-cloud reconstruction model). Optionally, the data stored in the memory 602 may also be readable by the processor 601, the data and the program 604 may be stored in the same storage address, and the data and the program 604 may also be stored in different storage addresses.

The processor 601 and memory 602 may be disposed alone or integrated together, for example, integrated on the system-on-chip (SOC) of the terminal equipment.

For the specific way of performing the method for the 3D point-cloud reconstruction by the processor 601, references may be made to the relevant description in the above embodiments.

It should be understood that the steps of the above method embodiments may be completed through the logical circuit or software instructions in the form of hardware in the processor 601. The processor 601 may be a CPU, a digital signal processor (DSP), an application specific integrated circuit (ASIC), a field program gate array (FPGA) or other programmable logic devices, such as, discrete gates, transistor logic devices, or discrete hardware components.

An embodiment of the present application also provides network equipment, which includes at least one processor, a memory, and a computer program stored in memory can be executed by at least one processor. The computer program, when executed by the processor causes the steps in any of above-mentioned methods are implemented.

An embodiment of the present application also provides a computer-readable storage medium, having a computer program being stored thereon, which when executed by the processor, causes the steps in each method embodiment as above mentioned to be performed.

An embodiment of the present application provides a computer program product. The computer program product, when run on the cleaning robot, causes the cleaning robot to perform the steps in each method embodiment as above mentioned.

The embodiments described above are used only to illustrate the solution of the present application, rather than limiting the present application. Notwithstanding the detailed description of this application by reference to the foregoing embodiments, it should be understood for those of ordinary skills in the art that the solutions recorded in the foregoing embodiments may still be modified, or some of the features may be equivalently replaced. These modifications or replacements do not make the essence of the corresponding solution deviate from the spirit and scope of each solution of the embodiments of the present application, and thus shall all be included within the protection scope of the present application.

What is claimed is:

1. A method for a three-dimensional (3D) reconstruction of brain structure, comprising:
obtaining a two-dimensional (2D) image of a brain, inputting the 2D image of the brain into a trained 3D brain point-cloud reconstruction model to be processed, and outputting a 3D point-cloud of the brain;
wherein the 3D brain point-cloud reconstruction model comprises: a residual network (ResNet) encoder and a graphic convolutional neural network, the ResNet encoder is configured to extract a coding feature vector of the 2D image of the brain, and the graphic convolutional neural network is configured to construct the 3D point-cloud of the brain according to the coding feature vector.

2. The method according to claim 1, wherein the graphic convolutional neural network comprises multiple sets of graphic convolution modules and branch modules, arranged alternatively, each graphic convolution module is configured to adjust position coordinates of point-clouds, and each branch module is configured to expand the number of point-clouds.

3. The method according to claim 1, wherein the 3D brain point-cloud reconstruction model is obtained by training based on a set of training samples and a corresponding discriminator; the set of training samples comprises multiple training samples, each training sample comprises a 2D brain image sample, and a 3D point-cloud sample of the brain corresponding to the 2D brain image sample.

4. The method according to claim 3, wherein a training for the 3D brain point-cloud reconstruction model comprises:
inputting, for each training sample, the 2D brain image sample in the training sample into an initial neural network model, to obtain a predicted 3D point-cloud;
inputting the predicted 3D point-cloud and the 3D point-cloud sample in the training sample into the discriminator to be processed, so as to obtain a discrimination result of the training sample; and
performing, according to the discrimination result of each training sample, an iterative training on a loss function of the 3D brain point-cloud reconstruction model and a loss function of the discriminator to obtain the 3D brain point-cloud reconstruction model.

5. The method according to claim 4, wherein the loss function of the 3D brain point-cloud reconstruction model is expressed as
$${L}_{E , G} = {λ}_{1} {L}_{K L} + {λ}_{2} {L}_{C D} + {E}_{z \sim Z} \left[D \left(G \left(z\right)\right)\right] ;$$
wherein, L_{E,G} represents a loss value corresponding to the 3D brain point-cloud reconstruction model; λ₁ and λ₂ are constants; L_{KL} represents a KL divergence; Z represents a distribution of the coding feature vector generated by the ResNet encoder; z represents the coding feature vector; G(•) represents an output of the graph convolutional neural network, D(•) represents the discriminator, E(•) represents an expectation; L_{CD} is a chamfer distance between the 3D point-cloud predicted by the initial neural network model and the 3D point-cloud sample.

6. The method according to claim 4, wherein the loss function of the discriminator is expressed as:
$$\begin{matrix}{L}_{D} = {E}_{z \sim Z} \left[D \left(G \left(z\right)\right)\right] - {E}_{Y \sim R} \left[D \left(Y\right)\right] + {λ}_{g p} {E}_{\hat{x}} \left[\left({\left‖{∇}_{\hat{x}} D \left(\hat{x}\right)\right‖}_{2} -\right)\right) \\ \left({\left(1\right)}^{2}\right] ;\end{matrix}$$
wherein, x̅ represents a sampling of linear segmentation between the 3D point-cloud sample and 3D point-cloud predicted by the initial neural network model, x̅ = G(z) - Y ; E(•) represents an expectation, G(•) represents an output of the graph convolutional neural network, D(•) represents the discriminator; Y represents 3D point-cloud sample; R represents a distribution of the 3D point-cloud sample; λ_{gp} is a constant; ∇ is a gradient operator.

7. The method according to claim 3, wherein the training sample is obtained by:
obtaining a 3D image of the brain;
performing an image pre-processing on the 3D image of the brain, and then slicing the 3D image of the brain to obtain the 2D brain image sample; and
obtaining the 3D point-cloud sample of the brain according to the 3D image.

8. (canceled)

9. Terminal equipment, comprising a memory, a processor, and a computer program that is stored in the memory and is executable by the processor, wherein the computer program, when executed by a processor, the processor is configured to, when executing the computer program, perform operations that comprises:
obtaining a two-dimensional (2D) image of a brain, inputting the 2D image of the brain into a 3D brain point-cloud reconstruction model that has been trained, to be processed, and outputting a 3D point-cloud of the brain;
wherein the 3D brain point-cloud reconstruction model comprises: a residual network (ResNet) encoder and a graphic convolutional neural network, the ResNet encoder is configured to extract a coding feature vector of the 2D image of the brain, and the graphic convolutional neural network is configured to construct the 3D point-cloud of the brain according to the coding feature vector.

10. A non-transitory computer readable storage medium, on which a computer program is stored, wherein the computer program, when executed by a processor, causes the processor to perform operations that comprises:
obtaining a two-dimensional (2D) image of a brain, inputting the 2D image of the brain into a 3D brain point-cloud reconstruction model that has been trained, to be processed, and outputting a 3D point-cloud of the brain;
wherein the 3D brain point-cloud reconstruction model comprises: a residual network (ResNet) encoder and a graphic convolutional neural network, the ResNet encoder is configured to extract a coding feature vector of the 2D image of the brain, and the graphic convolutional neural network is configured to construct the 3D point-cloud of the brain according to the coding feature vector.

11. The non-transitory computer readable storage medium according to claim 10, wherein the graphic convolutional neural network comprises multiple sets of graphic convolution modules and branch modules arranged alternatively, each graphic convolution module is configured to adjust position coordinates of point-clouds, and each branch module is configured to expand the number of point-clouds.

12. The non-transitory computer readable storage medium according to claim 10, wherein the 3D brain point-cloud reconstruction model is obtained by training based on a set of training samples and a corresponding discriminator; the set of training samples comprises multiple training samples, each training sample comprises a 2D brain image sample, and a 3D point-cloud sample of the brain corresponding to the 2D brain image sample.

13. The non-transitory computer readable storage medium according to claim 11, wherein the 3D brain point-cloud reconstruction model is obtained by training based on a set of training samples and a corresponding discriminator; the set of training samples comprises multiple training samples, each training sample comprises a 2D brain image sample, and a 3D point-cloud sample of the brain corresponding to the 2D brain image sample.

14. The non-transitory computer readable storage medium according to claim 12, wherein a training for the 3D brain point-cloud reconstruction model comprises:
inputting, for each training sample, the 2D brain image sample in the training sample into an initial neural network model, to obtain a predicted 3D point-cloud;
inputting the predicted 3D point-cloud and the 3D point-cloud sample in the training sample into the discriminator to be processed, so as to obtain a discrimination result of the training sample; and
performing, according to the discrimination result of each training sample, an iterative training on a loss function of the 3D brain point-cloud reconstruction model and a loss function of the discriminator to obtain the 3D brain point-cloud reconstruction model.

15. The non-transitory computer readable storage medium according to claim 14, wherein the loss function of the 3D brain point-cloud reconstruction model is expressed as L_{E,G} = λ₁L_{kL} ⁺ Å₂L_{CD} + E_{z∼Z} [D(G(z))] ;
wherein, L_{E,G} represents a loss value corresponding to the 3D brain point-cloud reconstruction model; λ₁ and λ₂ are constants; L_{KL} represents a KL divergence; Z represents a distribution of the coding feature vector generated by the ResNet encoder; z represents the coding feature vector; G(•) represents an output of the graph convolutional neural network, D(•) represents the discriminator and E(•) represents an expectation; LCD is a chamfer distance between the 3D point-cloud predicted by the initial neural network model and the 3D point-cloud sample.

16. The non-transitory computer readable storage medium according to claim 14, wherein the loss function of the discriminator is expressed as:
$$\begin{matrix}{L}_{D} = {E}_{z \sim Z} \left[D \left(G \left(z\right)\right)\right] - {E}_{Y \sim R} \left[D \left(Y\right)\right] + {λ}_{g p} {E}_{\hat{x}} \left[\left({\left‖{∇}_{\hat{x}} D \left(\hat{x}\right)\right‖}_{2} -\right)\right) \\ \left({\left(1\right)}^{2}\right] ;\end{matrix}$$
wherein, x̅ represents a sampling of linear segmentation between the 3D point-cloud sample and 3D point-cloud predicted by the initial neural network model, x̅ = G(z) - Y; E(•) represents an expectation, G(•) represents an output of the graph convolutional neural network, and D(•) represents the discriminator; Y represents 3D point-cloud sample; R represents a distribution of the 3D point-cloud sample; λ_{gp} is a constant; ∇ is a gradient operator.

17. The non-transitory computer readable storage medium according to claim 12, wherein the training sample is obtained by:
obtaining a 3D image of the brain;
performing an image pre-processing on the 3D image of the brain, and then slicing the 3D image of the brain to obtain the 2D brain image sample; and
obtaining the 3D point-cloud sample of the brain according to the 3D image.

18. The non-transitory computer readable storage medium according to claim 13, wherein the training sample is obtained by:
obtaining a 3D image of the brain;
performing an image pre-processing on the 3D image of the brain, and then slicing the 3D image of the brain to obtain the 2D brain image sample; and
obtaining the 3D point-cloud sample of the brain according to the 3D image.

19. The method according to claim 2, wherein the 3D brain point-cloud reconstruction model is obtained by training based on a set of training samples and a corresponding discriminator; the set of training samples comprises multiple training samples, each training sample comprises a 2D brain image sample, and a 3D point-cloud sample of the brain corresponding to the 2D brain image sample.

20. The method according to claim 19, wherein the training sample is obtained by:
obtaining a 3D image of the brain;
performing an image pre-processing on the 3D image of the brain, and then slicing the 3D image of the brain to obtain the 2D brain image sample; and
obtaining the 3D point-cloud sample of the brain according to the 3D image.
